(19) United States
(12) Patent Application Publication
(10) Pub. No.: US 2012/0314009 A1
(43) Pub. Date: Dec. 13, 2012

(54) LIQUID EJECTION APPARATUS

(75) Inventor: Nagatoshi KASAHARA, Shiojiri (JP)

(73) Assignee: SEIKO EPSON CORPORATION, Tokyo (JP)

(21) Appl. No.: 13/491,361

(22) Filed: Jun. 7, 2012

(30) Foreign Application Priority Data
Jun. 8, 2011 (JP) 2011-128394

(51) Int. Cl. B41J 2/175

(52) U.S. Cl. 347/88

(57) ABSTRACT

A liquid ejection apparatus includes a liquid storing unit that stores a liquid, a liquid ejection head that ejects the liquid, a supply tube having one end connected to the liquid storing unit and the other end connected to the liquid ejection head so that the liquid is supplied from the liquid storing unit to the liquid ejection head, a heating unit that heats a fluid, and a circulation tube in which the fluid that has been heated in the heating unit circulate therethrough, wherein the circulation tube is wound on the supply tube at least on the side of the liquid ejection head.

The entire disclosure of Japanese Patent Application No. 2011-128394, filed Jun. 8, 2011 is expressly incorporated by reference herein.

### BACKGROUND

1. Technical Field

The present invention relates to liquid ejection apparatuses having a liquid ejection head that ejects a liquid.

2. Related Art

Liquid ejection apparatuses having a liquid ejection head that ejects liquid droplets include ink jet recording apparatuses having an ink jet recording head in which pressure is generated in pressure generating chambers by means of a pressure generating unit so that ink droplets are ejected through nozzles that communicate with the pressure generating chambers.

When ink having high viscosity is used in the ink jet recording apparatus, since the ink viscosity is too high in a room temperature, ink is heated to reduce the viscosity.

JP-A-2004-314346 discloses an ink jet recording apparatus in which a two-layered tube is provided as a supply tube for supplying ink from a liquid storing section that stores ink to an ink jet recording head. Ink and heated warm water are introduced into the supply tube so that the ink flowing through the supply tube is heated by the warm water.

Further, JP-A-2009-233900 discloses a supply tube for supplying ink from a liquid storing section to an ink jet recording head that is helically wound on a heater.

However, when ink is heated in the two-layered tube such as that described in JP-A-2004-314346 by using a heated fluid flowing in an outer layer of the two-layered tube, a connection section is required to circulate the fluid in the outer layer of the two-layered tube. In this case, a gap may be formed between the connection section and the ink jet recording head, which causes a problem in that stagnation of the fluid flow is generated and ink fails to be uniformly heated.

Further, the supply tube that is wound on the heating unit such as a heater as described in JP-A-2009-233900 has a problem in that it is difficult to apply such a supply tube to a so-called serial type ink jet recording apparatus which performs printing while moving the ink jet recording head that is mounted on a carriage in a main scan direction and moving a target recording medium such as a sheet of paper in a sub-scan direction.

The above-mentioned problems exist not only in ink jet recording apparatuses but also in liquid ejection apparatuses that eject a liquid other than ink.

### SUMMARY

An advantage of some aspects of the invention is that a liquid ejection apparatus that is capable of ejecting a liquid while moving a liquid ejection head, and achieving stable liquid ejection properties by supplying a liquid that has been heated to a desired temperature is provided.

According to an aspect of the invention, a liquid ejection apparatus includes a liquid storing unit that stores a liquid, a liquid ejection head that ejects the liquid, a supply tube having one end connected to the liquid storing unit and the other end connected to the liquid ejection head so that the liquid is supplied from the liquid storing unit to the liquid ejection head, a heating unit that heats a fluid, and a circulation tube in which the fluid that has been heated in the heating unit circulate therethrough, wherein the circulation tube is wound on the supply tube at least on the side of the liquid ejection head. Accordingly, in the above aspect of the invention, it is possible to heat the liquid to a desired temperature without causing stagnation in the flow of the heated fluid. Further, since the circulation tube is helically wound on the outer periphery of the supply tube, it is possible to ensure heating of the liquid that is supplied to the liquid ejection head, even if the liquid ejection head is configured to eject the liquid while moving in a direction intersecting with a transportation direction of a target recording medium.

According to the above aspect of the invention, a flow direction of the fluid flowing in the circulation tube is preferably opposite to a supply direction of the liquid that is supplied from the liquid storing unit of the supply tube to the liquid ejection head. Accordingly, the liquid immediately before being supplied to the liquid ejection head can be heated by the heated fluid having the highest temperature. Therefore, it is possible to heat the liquid to a desired temperature while controlling the heating unit without difficulty.

### BRIEF DESCRIPTION OF THE DRAWINGS

The invention will be described with reference to the accompanying drawings, wherein like numbers reference like elements.

FIG. 1 is a schematic perspective view of a recording apparatus according to a first embodiment.

FIG. 2 is a schematic configuration sectional view of an essential part of the recording apparatus according to the first embodiment.

FIGS. 3A and 3B are essential schematic views of a modified example of the recording apparatus according to the first embodiment.

### DESCRIPTION OF EXEMPLARY EMBODIMENTS

The invention will be described below in detail with reference to embodiments thereof.

### First Embodiment

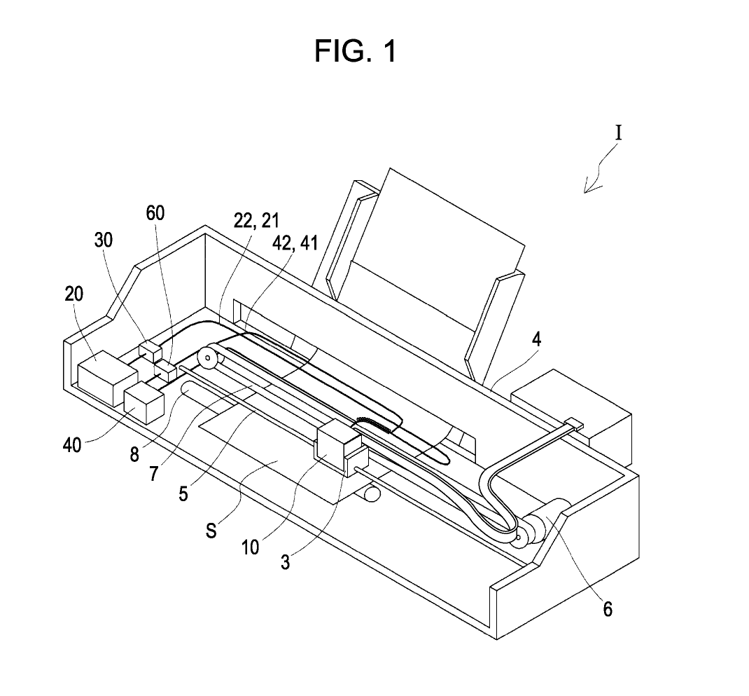

FIG. 1 is a schematic perspective view of an ink jet recording apparatus as an example of a liquid ejection apparatus according to a first embodiment of the invention.

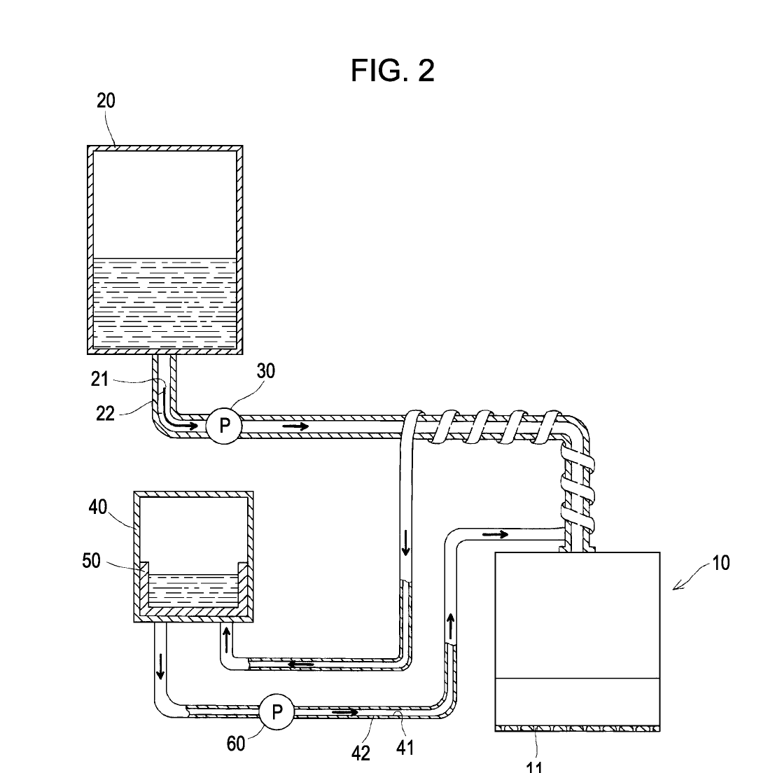

FIG. 2 is a schematic sectional view of an essential part of the ink jet recording apparatus.

As shown in the figures, an ink jet recording apparatus I as an example of a liquid ejection apparatus includes an ink jet recording head 10 that is configured to eject ink droplets as liquid.

The ink jet recording head 10 (hereinafter also referred to as a recording head 10) has nozzle openings 11 through which ink droplets are ejected and flow channels (not shown) that communicate with the nozzle openings 11 inside the ink jet recording head 10. Further, although not shown in the figures, a pressure generating unit that generates pressure change in the flow channels is provided inside the recording head 10. When a pressure change generated by the pressure generating unit is applied to ink in the flow channels, ink droplets are ejected through the nozzle openings 11. The pressure generating unit may include, for example, a longitudinal vibration piezoelectric actuator in which piezoelectric materials and electrode forming materials are alternately laminated so as to expand and contract in the axial direction, and a flexural vibration piezoelectric actuator such as of thin film type in which electrodes and piezoelectric materials are laminated by a film forming process or lithography process or thick film type formed by adhering a green sheet. The pressure generating unit further includes that having heat generating elements disposed in the flow channels so that bubbles are generated by heat from the heat generating elements, which causes liquid droplets to be ejected through the nozzle openings, and that using a so-called electrostatic actuator that generates static electricity between a vibration plate and an electrode so that the vibration plate is deformed by an electrostatic force, which causes liquid droplets to be ejected through the nozzle openings.

The above-mentioned recording head 10 is mounted on a carriage 3. The carriage 3 is movable in the axial direction of a carriage shaft 5 that is disposed in an apparatus body 4.

When a driving force from a drive motor 6 is transmitted to the carriage 3 via a plurality of gears, which are not shown, and a timing belt 7, the carriage 3 on which the recording head 10 is mounted moves along the carriage shaft 5. Moreover, the apparatus body 4 is provided with a platen 8 that extends along the carriage shaft 5 such that a recording sheet S which is a recording medium such as a sheet of paper fed by paper feeding rollers, which are not shown, is wound and transported on the platen 8.

The ink jet recording apparatus I further includes a liquid storing section 20 which is a liquid storing unit in which ink is stored and is secured on the apparatus body 4. The liquid storing section 20 is connected to a supply tube 22 that defines a supply path 21 through which ink is supplied to the recording head 10.

The supply tube 22 is formed of a tubular member such as a flexible tube and the supply path 21 is provided therein. The supply tube 22 has one end that is connected to the liquid storing section 20 and the other end that is connected to the flow channel of the recording head 10 so that ink in the liquid storing section 20 is supplied to the recording head 10 through the supply path 21.

Further, a pressure pump 30 which is a pumping unit that pumps ink in the liquid storing section 20 to the recording head 10 is disposed at a position in the supply path 21. The ink in the liquid storing section 20 is supplied to the recording head 10 at a specific pressure by a pumping of the pressure pump 30. In addition, a pressure control unit having a valve element that opens by a pressure of the flow channel is provided in the recording head 10 so that the flow channel is filled with ink when the valve element opens. If the pressure control unit is not provided in the recording head 10, ink flows out from the nozzle openings 11 of the recording head 10 when ink is supplied to the recording head 10 by pumping of the pressure pump 30 regardless of whether the pressure generating unit is driven or not.

The ink jet recording apparatus I also includes a heated fluid storing section 40 in which a fluid is stored which is secured to the apparatus body 4.

The heated fluid storing section 40 has a heating unit 50 such as an electric thermal heater so as to heat a fluid stored therein. The heated fluid storing section 40 may contain a liquid such as water and oil or various gases.

Further, the heated fluid storing section 40 is connected to a circulation tube 42 that defines a circulation path 41. The circulation tube 42 is formed of a tubular member such as a flexible tube and the circulation path 41 is provided therein. A pressure pump 60 which is a pumping unit is disposed at a position in the circulation tube 42 so that the fluid stored in the heated fluid storing section 40 is circulated through the circulation path 41.

The circulation tube 42 is helically wound on the supply tube 22 at least on the side of the recording head 10. In this embodiment, the circulation tube 42 is wound on the outer periphery of the supply tube 22 so that the fluid flows through the circulation path 41 in a direction opposite to a supply direction of ink that is supplied through the supply path 21 from the liquid storing unit 20 to the recording head 10.

When the heated fluid circulates through the circulation path 41 of the circulation tube 42, ink which flows through the supply path 21 of the supply tube 22 can be heated by the heated fluid circulating through the circulation path 41. That is, ink which is supplied from the liquid storing section 20 to the recording head 10 can be heated.

Since the circulation tube 42 in which the heated fluid circulates is helically wound on the supply tube 22 through which ink is supplied, it is possible to supply ink which has been heated to a desired temperature to the recording head 10 even if the recording head 10 in the ink jet recording apparatus I is configured to eject ink droplets while moving in a direction intersecting with a transportation direction of the recording sheet S.

In addition, since the circulation tube 42 in which the heated fluid circulates is helically wound on the supply tube 22 through which ink is supplied, it is possible to provide a longer length of the circulation tube 42 that is in contact with the supply tube 22 in a limited space, and to heat ink to a desired temperature in a small space. Accordingly, in the case where ink having a high viscosity is supplied, ink can be sufficiently heated without a need to control the heating unit 50 to a high temperature, thereby decreasing the ink viscosity and ensuring stable ink supply. As a result, ink can be uniformly heated even if different ejection frequencies are used so that a constant amount of ink can be supplied.

Further, variation in heating temperature of ink can be eliminated, and variation in ejection properties of ink droplets due to ink viscosity can be suppressed so as to ensure a stable printing quality.

Moreover, ink can be heated to a predetermined temperature without requiring unduly high capability of the heating unit 50 (without unduly increasing the temperature of the heating unit 50), since a sufficient flow channel length of the circulation path 41 that is in contact with the supply tube 22 in which ink flows can be provided in a limited space. In other words, when ink is heated to a certain temperature, the temperature of the heating unit 50 can be relatively decreased. Accordingly, a high temperature component is not necessary in the apparatus that is frequently touched by a large number of people, thereby eliminating a factor that may be a risk, and providing a sufficient safety.

Further, in this embodiment, a flow direction of the heated fluid flowing through the circulation path 41 is opposite to a flow direction of ink flowing through the supply path 21. Accordingly, ink immediately before being supplied to the recording head 10 can be heated by the heated fluid having a temperature closest to the temperature of the heating unit 50. Therefore, it is possible to control the temperature of ink with high accuracy and ensure more stable ink ejection properties in ejection of ink droplets. If the flow direction of the heated fluid flowing through the circulation path 41 is the same as the flow direction of ink flowing through the supply path 21, the temperature of the fluid that has been heated in the heating unit 50 is gradually lowered as the fluid passes through the circulation path 41, and heat of the fluid is absorbed by ink flowing through the supply path 21. This leads to a problem that ink immediately before being supplied to the recording head 10 may be heated by the fluid having a temperature below the heating temperature of the heating unit 50. In this case, since ink temperature may deviate from the heating temperature of the fluid by the heating unit 50, the heating temperature of the fluid by the heating unit 50 has to be controlled taking into consideration such difference of temperature, resulting in a large error between the actual ink temperature and the heating temperature.

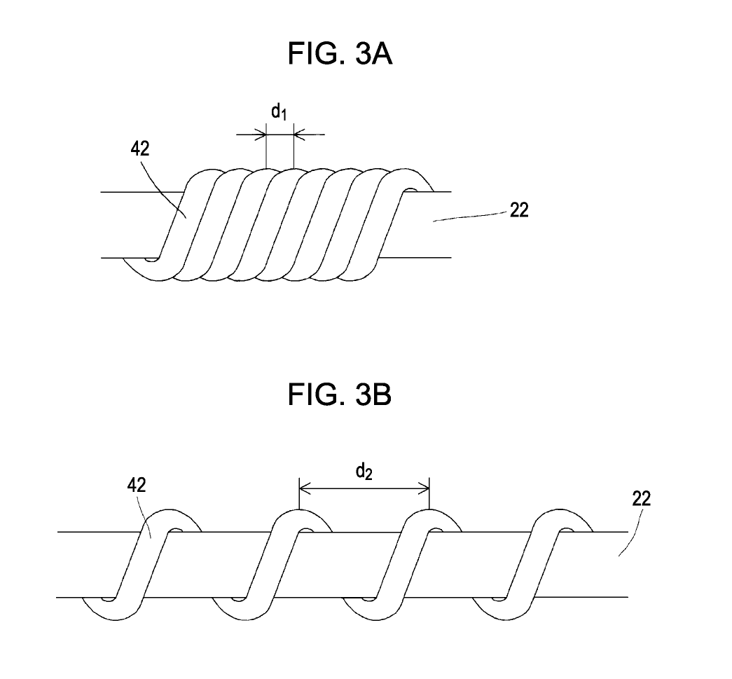

As shown in FIG. 3A, when a winding distance d₁ of the circulation tube 42 wound on the supply tube 22 is small, a surface area of the supply tube 22 (supply path 21) that is in contact with the circulation path 41 becomes large, which makes it possible to improve a capability to heat ink. On the other hand, as shown in FIG. 3B, when a winding distance d₂ of the circulation tube 42 wound on the supply tube 22 is large, a surface area of the supply tube 22 (supply path 21) that is in contact with the circulation path 41 becomes small, which makes it possible to provide a short length of the circulation path 41 and suppress heat dissipation of the fluid flowing in the circulation path 41, but decreases a capability to heat ink flowing in the supply path 21.

Accordingly, the winding distance of the circulation tube 42 wound on the supply tube 22 may be decided as appropriate depending on a temperature of ink supplied to the recording head 10 and a heating capability of the heating unit 50.

### Other Embodiment

Although one embodiment of the invention has been described above, the essential configuration of the invention is not limited thereto. For example, although the circulation tube 42 is helically wound on the supply tube 22 only on the side of the recording head 10 in the first embodiment, the invention is not specifically limited thereto, and the circulation tube 42 may be wound over the entire length of the supply tube 22.

Further, although the ink jet recording apparatus I of the above embodiment is described as having the ink jet recording head 10 that is mounted on the carriage 3 and moves in the main scan direction, the invention is not specifically limited thereto. For example, the invention is also applicable to a so-called line type recording apparatus in which the ink jet recording head 10 is provided at a fixed position and printing is performed just by transporting the recording sheet S such as a sheet of paper in a sub-scan direction.

Moreover, although the ink jet recording apparatus having the ink jet recording head has been described as an example of liquid ejection apparatus in the above embodiment, the invention is generally directed to liquid ejection apparatuses having a liquid ejection head, and may be applied to liquid ejection apparatuses having a liquid ejection head that ejects a liquid other than ink. Examples of other liquid ejection heads include, for example, various recording heads used for image recording apparatuses for printers and the like, color material ejecting heads used for manufacturing of the color filters for liquid crystal displays and the like, organic EL displays, electrode material ejecting heads used for forming electrode such as field emission displays (FED), and bioorganic ejecting heads used for manufacturing bio chips and the like, and the invention may be applied to liquid ejection apparatuses having the above liquid ejection heads.

What is claimed is:

1. A liquid ejection apparatus comprising:
a liquid storing unit that stores a liquid;
a liquid ejection head that ejects the liquid;
a supply tube having one end connected to the liquid storing unit and the other end connected to the liquid ejection head so that the liquid is supplied from the liquid storing unit to the liquid ejection head;
a heating unit that heats a fluid; and
a circulation tube in which the fluid that has been heated in the heating unit circulate therethrough,
wherein the circulation tube is wound on the supply tube at least on the side of the liquid ejection head.

2. The liquid ejection apparatus according to claim 1, wherein a flow direction of the fluid flowing in the circulation tube is opposite to a supply direction of the liquid that is supplied from the liquid storing unit of the supply tube to the liquid ejection head.
